(19) United States
(12) Patent Application Publication
(10) Pub. No.: US 2026/0048511 A1
(43) Pub. Date: Feb. 19, 2026

(54) PARTICLE FILTERING FOR LEARNING OBJECT PHYSICS FROM ROBOT INTERACTION VIDEOS

(71) Applicant: Toyota Research Institute, Inc., Los Altos, CA (US)

(72) Inventors: Sergey Zakharov, San Francisco, CA (US); Katherine Liu, Mountain View, CA (US); Rares A. Ambrus, San Francisco, CA (US); Kris Kitani, Pittsburgh, PA (US); Junyu Nan, Pittsburgh, PA (US)

(73) Assignees: Toyota Research Institute, Inc., Los Altos, CA (US); Toyota Jidosha Kabushiki Kaisha, Toyota-shi Aichi-ken (JP); Carnegie Mellon University, Pittsburgh, PA (US)

(21) Appl. No.: 19/279,406

(22) Filed: Jul. 24, 2025

Related U.S. Application Data
(60) Provisional application No. 63/683,879, filed on Aug. 16, 2024.

(51) Int. Cl. B25J 9/16

(52) U.S. Cl. CPC B25J 9/1697; B25J 9/161

(57) ABSTRACT

A method may include receiving training data comprising a plurality of RGB-D images of an object at a plurality of time steps, and a plurality of robot actions associated with the object at the plurality of time steps; and optimizing, using the training data, a dynamics function to predict a future state of the object based on a current state of the object and a robot action. A state of the object is estimated as a plurality of particles comprising 3D Gaussians using particle filtering.

### CROSS-REFERENCE TO RELATED APPLICATION

The present specification is based on, and claims the benefit of U.S. Provisional Application No. 63/683,879, filed Aug. 16, 2024, the disclosure of which is hereby incorporated by reference in its entirety.

### TECHNICAL FIELD

The present specification relates to learning object physics, and more particularly, particle filtering for learning object physics from robot interaction videos.

### BACKGROUND

Learning deformable object dynamics often relies on knowing ground-truth particle trajectories as supervision. However, tracking particles in real-world robot interaction videos is challenging due to limited visual cues and complex deformations, especially for soft materials like dough or sponge. Gaussian splatting may be used to represent object dynamics. However, complex deformations may require many Gaussians, making efficiency crucial. As such, there exists a need for particle filtering for learning object physics from robot interaction videos.

### SUMMARY

In one embodiment, a method may include receiving training data comprising a plurality of RGB-D images of an object at a plurality of time steps, and a plurality of robot actions associated with the object at the plurality of time steps. The method may further include optimizing, using the training data, a dynamics function to predict a future state of the object based on a current state of the object and a robot action. A state of the object may be estimated as a plurality of particles comprising 3D Gaussians using particle filtering.

In another embodiment, a computing device may comprise one or more processors configured to receive training data comprising a plurality of RGB-D images of an object at a plurality of time steps, and a plurality of robot actions associated with the object at the plurality of time steps. The one or more processors may further optimize, using the training data, a dynamics function to predict a future state of the object based on a current state of the object and a robot action. A state of the object may be estimated as a plurality of particles comprising 3D Gaussians using particle filtering.

In another embodiment, a non-transitory computer readable storage medium may store a program. When executed by a processor, the program may cause the processor to receive training data comprising a plurality of RGB-D images of an object at a plurality of time steps, and a plurality of robot actions associated with the object at the plurality of time steps. The program may further cause the processor to optimize, using the training data, a dynamics function to predict a future state of the object based on a current state of the object and a robot action. A state of the object may be estimated as a plurality of particles comprising 3D Gaussians using particle filtering.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 depicts a system for particle filtering for learning object physics from robot interaction videos, according to one or more embodiments shown and described herein;

FIG. 2 illustrates an example framework for predicting a future object state based on a current object state and a robot action state, according to one or more embodiments shown and described herein;

FIG. 3 depicts an example neural network for learning a dynamics function, according to one or more embodiments shown and described herein;

FIG. 4 depicts a schematic diagram of a computing device for performing particle filtering for learning object physics from robot interaction videos, according to one or more embodiments shown and described herein;

FIG. 5 illustrates the training process and the inference process for performing particle filtering for learning object physics from robot interaction videos, according to one or more embodiments shown and described herein; and

FIG. 6 depicts a flowchart of an example method for operating the computing device of FIG. 4, according to one or more embodiments shown and described herein.

### DETAILED DESCRIPTION

The embodiments disclosed herein are directed to particle filtering for learning object physics from robot interaction videos. In embodiments, a system may learn a dynamics model that takes a state of an object and a robot action, and predict future states of the object. Once the dynamics model is learned for a particular object, an arbitrary object state and an arbitrary robot action may be input to the dynamics model, and the dynamics model may predict future states of the object.

In embodiments, a framework jointly optimizes deformable object states and dynamics via particle filtering over 3D Gaussians. In embodiments, Gaussians are dynamically resampled based on covariance and opacity adapting to topological changes and enabling robust tracking of deformed objects with weak visual cues. A dynamics model disclosed herein uses a mixed particle-grid representation, which propagates particle features to a grid, updates dynamics on grid nodes, and interpolates updates back, thereby improving scalability for large particle sets.

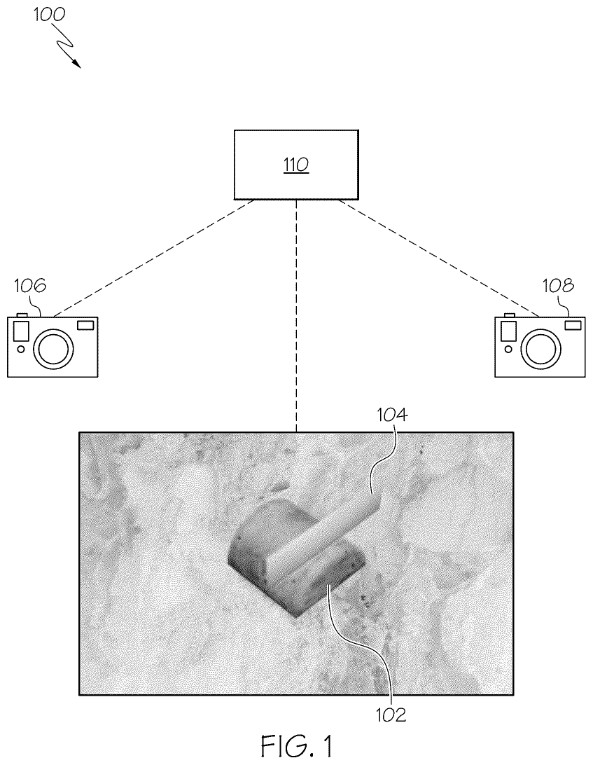

Turning now to the figures, FIG. 1 illustrates a system 100 for implementing the framework disclosed herein. In the example of FIG. 1, the system 100 includes a deformable object 102 and a robot 104. In the illustrated example, the robot 104 comprises a cutting arm that can slice the object 102. However, in other examples, the robot 104 may comprise other types or shapes. For example, the robot 104 may comprise one or more robotic arms or other tools that may interact with the object 102. The robot 104 may record the actions it performs, and transmit this data to a computing device 110, as discussed in further detail below.

In the example of FIG. 1, the system 100 also comprises RGB-D cameras 106 and 108. The cameras 106 and 108 may capture images of the robot 104 interacting with the object 102. In embodiments, the cameras 106, 108 capture RGB-D images (color images with depth values). The cameras 106 and 108 are positioned at different locations so as to capture images of the object 102 and the robot 104 from different perspectives. The camera intrinsics and extrinsics of the cameras 106 and 108 are known. In the illustrated example, the system 100 includes two cameras. However, in other examples, the system 100 may include any number of cameras that capture RGB-D images of the object 102 and the robot 104.

The system 100 also includes the computing device 110. The computing device 110 may be communicatively coupled to the cameras 106, 108 and the robot 104. As such, the computing device may receive images captured by the cameras 106, 108 and robot actions performed by the robot 104. This data may be used to implement the disclosed framework, as discussed in further detail below.

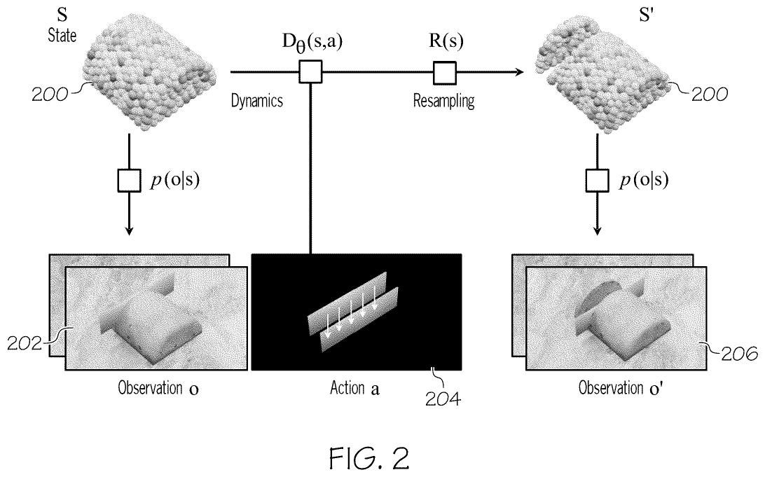

FIG. 2 illustrates the example framework disclosed herein for predicting a future object state based on a current object state and a robot action state. FIG. 2 includes an example deformable object 200. In embodiments disclosed herein, a dynamics model models the object 200 as a mixture of Gaussians, using Gaussian splatting, that transforms over time due to a robot action. In embodiments, object states are estimated from multiview RGB-D observations of robot interaction with deformable objects (e.g., as captured by the cameras 106, 108 of FIG. 1).

In the example of FIG. 2, a series of observations 202 (including Observation o as shown in FIG. 2) are made at a first time step. Data about an action 204 (Action a in FIG. 2) of a robot (e.g., the robot 104 of FIG. 1) is also recorded. In the example of FIG. 1, the action 204 is a blade making a slicing motion through the object 200. A series of observation 206 (including Observation o′ as shown in FIG. 1) are made at a subsequent time step.

In the example of FIG. 2, the object 200 is initially in a state S, and is subject to the action 204. A dynamics function [symbol] _{θ}(s, a) approximates a prediction of particles of the object 200 under the true dynamics model. A resampling function [symbol] (s) then adjusts the set of Gaussians associated with the object 200 to predict a state S′. The dynamics function and the resampling function are discussed in further detail below.

In embodiments disclosed herein, a system models deformable object dynamics using a particle filter over a collection of 3D Gaussians. Furthermore, the system dynamically resamples Gaussians, enabling a more flexible representation to handle objects undergoing large deformations. A dynamics model predicts the future state of an object given robot action by using a mixed particle-grid representation to improve inference speed over a large number of particles. The entire framework is trained end-to-end using rendering losses and physical constraints.

In embodiments, a system learns a dynamics function p(s′|s, a) that maps the state of an object s to the next state s′ given a robot action a. Input is given of a sequence of observed interactions (e.g., a robot interacting with a deformable object) [symbol] ={qⁱ}, where each interaction consists of a tuple: a sensor observation o in the form of an RGB-D image, a robot action a, and the resulting next observation o′,

$${q}^{i} = \{ ( {o}_{t}^{i} , {a}_{t}^{i} , {o}_{t + 1}^{i} ) \vert t = 0 , … , {T}^{i} \} . \qquad ( 1 )$$

The sensor observations oₜ can be interpreted as a noisy measurement of the true object state s, as it does not provide direct estimates of the underlying physical properties of the object, such as its position, velocity, shape that influence its dynamics.

Using the framework of Bayesian filtering, the state estimation problem is solved by computing the posterior distribution over states given the history of observations and actions

$$p ( {s}_{t} \vert {o}_{0 : t} , {a}_{0 : t - 1} ) \qquad ( 2 )$$

The computation of the posterior distribution can be decomposed into two steps, namely a prediction and an update:

$$p ( {s}_{t} \vert {o}_{t - 1} , {a}_{t - 1} ) = \int p ( {s}_{t} \vert {s}_{t - 1} , {a}_{t - 1} ) p ( {s}_{t - 1} \vert {o}_{t - 1} ) {ds}_{t - 1} , \qquad ( 3 )$$

$$p ( {s}_{t} \vert {o}_{t} ) ∝ p ( {o}_{t} \vert {s}_{t} ) p ( {s}_{t} \vert {o}_{t - 1} , {a}_{t - 1} ) \qquad ( 4 )$$

Equation (3) above represents the prediction step derived from marginalization, and equation (4) above represents the update step obtained by Bayes' rule.

When exact inference is intractable due to the high dimensionality of the state space, the posterior can be estimated in equation (2) using particle filtering, which uses point samples (particles) to approximate a probability density function.

In embodiments, a system uses a high dimensional state space and represents the state of a deformable object s by a set of 3D Gaussians,

$${s}_{t} = {G}_{t} = ( {X}_{t} , {R}_{t} , {S}_{t} , {SH}_{t} , {σ}_{t} ) , \qquad ( 5 )$$

where Xₜ represents the mean position, Rₜ and Sₜ define the covariance matrix

$${\sum }_{t} {R}_{t} {S}_{t} {S}_{t}^{T} {R}_{t}^{T} ,$$

SHₜ encodes the view-dependent appearance using spherical harmonics, and σₜ represents opacity. Note that the number of Gaussians in Gₜ may change over time steps through the resampling step, as discussed in further detail below.

Similarly, the robot action a is represented by a set of Gaussians plus their motions:

$${a}_{t} = {A}_{t} = ( {X}_{t} , {R}_{t} , {S}_{t} , {SH}_{t} , {σ}_{t} , Δ {X}_{t} , Δ {R}_{t} , Δ {S}_{t} ) \qquad ( 6 )$$

Where ΔSₜ is enforced to be zero vectors since the robot is assumed to consist of rigid links. For example, in a cutting sequence, as shown in FIG. 1, Aₜ will be a set of Gaussians reconstructing the blade that the robot holds, with shared ΔXₜ, ΔRₜ describing the cutting motion.

In the context of particle filtering, the Gaussians representing the deformable object of interest can be considered particles, where their opacities σₜ act as importance weights that describe the contribution of each Gaussian to the state estimate. In embodiment disclosed herein, the posterior distribution over the deformable object state sₜ=Gₜ is approximated by a mixture of Gaussians instead of a set of Dirac delta functions. Specifically, at each time step, the posterior distribution

$$p ( {s}_{t} \vert {o}_{0 : t} , {a}_{0 : t - 1} ) \approx {\sum }_{i = 1}^{N} {σ}_{c}^{( i )} 𝒩 ( {G}_{t} , {X}_{t}^{( i )} , {\sum }_{t}^{( i )} ) \qquad ( 7 )$$

The following procedure estimates the posterior distribution at each time step. At the initial time step t=0, the particles G₀ are initialized to match the sensor observations o₀. Using the rendering process of Gaussian Splatting, denoted as a rendering function [symbol] , the initial particles G₀ are initialized by solving:

$${G}_{0}^{*} = \begin{matrix}arg min \\ G\end{matrix} {ℒ}_{r e n d e r} [ ℋ ( G ) , o ] , \qquad ( 8 )$$

where [symbol] _{render} is the rendering loss function in RGB-D image space:

$${ℒ}_{r e n d e r} = {λ}_{SSIM} {ℒ}_{SSIM} + {λ}_{L 1} {ℒ}_{L 1} + {λ}_{d e p t h} {ℒ}_{d e pth} , \qquad ( 9 )$$

where λ_{SSIM}, λ_{L1} are weights for SSIM and L1 losses against ground truth RGB images, and λ_{depth} is weight of L1 loss against ground truth depth image. In practice, additional regulation losses are applied to optimize the shape and distribution of Gaussians at t=0.

Starting from t=1, the two-step state estimation process described above is applied. First, the particles are propagated to the next time step following the prediction step in equation (3):

$${\hat{G}}_{t} ∼ p ( {s}_{t} \vert {o}_{t - 1} , {a}_{t - 1} ) \approx {𝒟}_{θ} ( {G}_{t - 1} , {A}_{t - 1} ) \qquad ( 10 )$$

In equation (1), a function [symbol] _{θ}(Sₜ₋₁, aₜ₋₁) is introduced, which is a learnable dynamics function designed to approximate the one-step prediction of particles under the true dynamics model, as discussed in further detail below.

The update step requires specification of a likelihood function (observation model) p(oₜ|sₜ), which is approximated using the rendering loss from equation (9)

$$p ( {o}_{t} \vert {s}_{t} ) ∝ exp ( - {λℒ}_{r e n d e r} [ ℋ ( {G}_{t} ) , o ] ) \qquad ( 11 )$$

In traditional particle filtering, the update step typically reweights particles based on their likelihood under the current observation oₜ. However, as the likelihood is approximated by Gaussian opacity in disclosed embodiments, the weight update is approximated by the predicted Gaussian opacity updates \hat{σ}ₜ⁽ⁱ⁾ from the dynamics model in equation (10). A resampling step [symbol] then adjusts the set of Gaussians based on the updated importance weights \hat{σ}ₜ⁽ⁱ⁾. High-opacity Gaussians are duplicated by a splitting operation, while low-opacity Gaussians are removed by a merging operation to prevent sample degeneration. This adaptive process ensures that the particle distribution remains representative of the underlying deformable object state while maintaining computational efficiency. The resampling function [symbol] is discussed in further detail below.

Given the dynamics and resampling functions, the posterior distribution at time t is approximated as a weighted mixture of Gaussians as specified in equation (7), where the updated state Gₜ is obtained by applying the resampling function [symbol] to the predicted particles:

$${G}_{t} = ℛ ( {𝒟}_{θ} ( {G}_{t - 1} , {A}_{t - 1} ) ) \qquad ( 12 )$$

By repeating this process at each time step, the disclosed method recursively estimates the evolving state of the deformable object. This allows the representation to adapt dynamically to interactions, occlusions, and topological changes, ensuring a temporally coherent estimation of the object's deformation over time.

The above discussion describes a method for state estimation, assuming that the dynamics function [symbol] _{θ} is already learned. The following describes how the dynamics function is optimized within the state estimation framework. Given the state estimation formulas in equation (12), the parameters θ of the dynamics network [symbol] _{θ} are optimized against the rendering loss in equation (9) and an additional physical constraint loss. The rendering loss ensures the estimated states align with RGB-D observations, while the physics constraint loss ensures motion feasibility by ensuring the Gaussians move smoothly without drifting apart. The object function is defined as

$$\begin{matrix}arg min \\ θ\end{matrix} {\sum }_{t = 1}^{T} {ℒ}_{render} ( ℋ ( {𝒟}_{θ} ( {G}_{t - 1} , {A}_{t - 1} ) ) ) + {ℒ}_{physical}^{t} \qquad ( 13 )$$

where [symbol] _{physical} includes short-term local rigidity and rotational similarity measurements to encourage smooth motion in consecutive frames, plus long-term isometry to prevent points from drifting apart:

$${ℒ}_{physical}^{t} = {λ}_{r} {ℒ}_{rigid}^{t} + {λ}_{rot} {ℒ}_{rot}^{t} + {λ}_{i} {ℒ}_{i s o}^{t} \qquad ( 14 )$$

where λᵣ, λᵣₒₜ, λᵢ are weights for rigidity loss [symbol] _{rigid}, rotational similarity loss [symbol] ᵣₒₜ, and isometry loss [symbol] _{rigidiso}. [symbol] _{rigid}, [symbol] ᵣₒₜ, [symbol] ᵢₛₒ are summed over pairs of Gaussians that are close to each other at each time step, weighted by their relative distance at t=0:

$${ℒ}_{ϕ}^{t} = \frac{1}{k \vert {G}_{t} \vert} {\sum }_{{g}_{i} ∈ {G}_{t}} {\sum }_{{g}_{j} ∈ k n n ( {g}_{i} , k )} {ω}_{i , j} {l}_{ϕ}^{t} ( {g}_{i} , {g}_{j} ) \qquad ( 15 )$$

$${ω}_{i , j} = exp ( - {λ}_{ω} {‖ {X}_{j}^{0} - {X}_{i}^{0} ‖}_{2}^{2} ) \qquad ( 16 )$$

where ϕ∈{rigid, rot, iso} corresponds to rigidity, rotational similarity, and isometry losses between two Gaussians respectively. The losses are weighted by relative distances at t=0 to ensure that physical constraints are not enforced between particles that have been apart, which means that they are not physically related despite being close to each other at the current time step.

To learn the dynamics model [symbol] _{θ}(G, A) effectively over a large number of 3D Gaussians, the disclosed embodiments use a mixed particle-grid representation, as disclosed herein. This is a numerical technique used in fluid dynamics and plasma physics. In disclosed embodiments, particle attributes are projected to a fixed grid, the grid features are updated by exchanging information across nearby grid nodes, and the grid features are projected back to the particles to predict the future state of the particles. Since there is no explicit message passing between particles as in Graph Neural Networks, the disclosed embodiments significantly reduce computation cost.

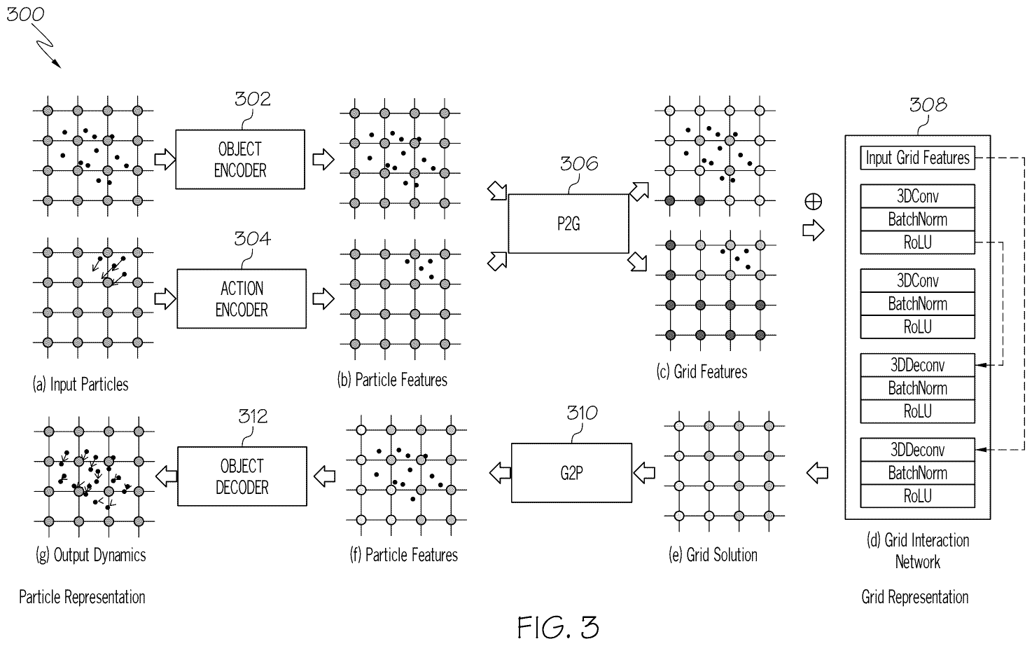

FIG. 3 shows an example neural network 300 for learning the parameters of the disclosed dynamics model. The neural network 300 of FIG. 3 comprises an object encoder 302, an action encoder 304, a particle-to-grid (P2G) module 306, a grid interaction network 308. a grid-to-particle (G2P) module 310, and an object decoder 312, each of which are discussed in further detail below. Each of the object encoder 302, the action encoder 304, the grid interaction network 308, and the object decoder 312 include learnable parameters that can be learned during training of the neural network 300.

In embodiments, the neural network 300 takes the Gaussians of the object G and the action Gaussians A as input. Each input is a set of particles B with positions X and features V. In this particle representation, each particle p=(x,v), where xₚ (xₚ, yₚ, zₚ) with xₚ, yₚ, zₚ denoting the particle coordinate in X, Y, and Z axes, and v obtained by encoding attributes of each object or action Gaussian. In particular, the object encoder 302 encodes the attributes of each object Gaussian and the action encoder 304 encodes the attributes of each action Gaussian.

The object encoder 302 generates object features by encoding attributes including opacity σ, det(SS^{T}) as an approximation of the volume, as well as ΔXₜ₋₁, ΔRₜ₋₁ to represent motion from the past time step:

$${V}_{t}^{g} = {f}_{e n c}^{g} ( {σ}_{t}^{g} , det ( {{S}^{g} ( {S}^{g} )}^{T} ) , Δ {X}_{t - 1}^{g} , Δ {R}_{t - 1}^{g} ) \qquad ( 17 )$$

The action encoder 304 generates action features by encoding σ and det(SS^{T}) of the action Gaussians, plus ΔXₜ, ΔRₜ to represent the action taken by the robot at the current time step:

$${V}_{t}^{a} = {f}_{e n c}^{a} ( {σ}_{t}^{a} , det ( {{S}^{a} ( {S}^{a} )}^{T} ) , Δ {X}_{t}^{a} , Δ {R}_{t}^{a} ) \qquad ( 18 )$$

In embodiments, as discussed above, particle attributes are projected to a fixed grid. The grid is represented by a set of M×M×M grid nodes, each with indices i=(i, j, k) where i, j, k∈[1, M], cartesian coordinates (ih, jh, kh) with h represents the grid spacing, and grid node features

$${N}_{t}^{g} .$$

Features are transferred back and forth between the grid and particle representation spaces through P2G and G2P operations. In particular, the P2G module 206 may convert a particle representation to a grid representation and the G2P module 210 may convert a grid representation to a particle representation.

The P2G module 306 computes grid features nᵢ from particles P by computing a projection weight for each particle p to each grid node i:

$${ω}_{i} ( {x}_{p} ) = 𝒦 ( {x}_{p} - ih ) 𝒦 ( {y}_{p} - jh ) 𝒦 ( {z}_{p} - kh ) , \qquad ( 19 )$$

Where [symbol] (x) is a cubic kernel defined as

$$( ) = \{ \begin{matrix}\frac{1}{2} {\vert \frac{x}{h} \vert}^{3} - {( \frac{x}{h} )}^{2} + \frac{2}{3} , & for 0 \leq x \leq h \\ 0 , & otherwise\end{matrix} \qquad ( 20 )$$

The P2G module 306 computes each grid node feature nᵢ as a weighted average over all particle features vₚ:

$${n}_{i} = {\sum }_{p} \frac{{ω}_{i} ( {x}_{p} )}{{\sum }_{p} {ω}_{i} ( {x}_{p} )} {v}_{p} \qquad ( 21 )$$

Similarly, the G2P module 308 computes the particle features vₚ as the weighted average over grid features nᵢ:

$${v}_{p} = {\sum }_{i} \frac{{ω}_{i} ( {x}_{p} )}{{\sum }_{i} {ω}_{i} ( {x}_{p} )} {n}_{i} \qquad ( 22 )$$

The object decoder 312 projects particle features by f_{dec} into particle updates space ΔGₜ parameterized by (ΔXₜ, ΔRₜ, ΔSₜ, Δσ):

$${\hat{G}}_{t} = {G}_{t} ⊕ Δ {G}_{t} \qquad ( 23 )$$

$$= ( {X}_{t} + Δ {X}_{t} + Δ {R}_{t} \cdot {R}_{t} , {S}_{t} + Δ {S}_{t} , SH , σ + Δσ ) , \qquad ( 24 )$$

Where spherical harmonics term SH is consistent across time, ΔXₜ, ΔRₜ, ΔSₜ correspond to the motion of particles as a result of robot action in the prediction step of particle filtering, and Δσ corresponds to adjusting weights of samples in the update step.

In embodiments, given input object

$$( {X}_{t}^{g} , {V}_{t}^{g} )$$

and action Gaussians

$$( {X}_{t}^{a} , {V}_{t}^{a} )$$

in particle representation, where particle features are extracted by encoders as defined in equation (17) and (18) above, ΔGₜ is predicted by the following steps:

$${N}_{t}^{g} = P 2 G ( {V}_{t}^{g} , {X}_{t}^{g} ) , {N}_{t}^{a} = P 2 G ( {V}_{t}^{a} , {X}_{t}^{a} ) \qquad ( 25 )$$

$${N}_{t + 1}^{g} = {f}_{grid} ( {N}_{t}^{g} , {X}_{t}^{a} ) \qquad ( 26 )$$

$${V}_{t + 1}^{g} = G 2 P ( {N}_{t + 1}^{g} , {X}_{t}^{g} ) \qquad ( 27 )$$

$$Δ {G}_{t} = {f}_{dec} ( {V}_{t + 1}^{g} , {V}_{t}^{g} ) \qquad ( 28 )$$

where particle encoders

$${f}_{enc}^{g} , {f}_{enc}^{a}$$

and particle decoders f_{dec} are MLPs, and f_{grid} is implemented by the grid interaction network 308.

Given equation (20), the weights ωᵢ (xₚ) only need to be computed between the 8 closest grid nodes for each particle p. Therefore, the computational complexity of the P2G and G2P operations is O(M³+N), where M is the grid dimension and N is the number of particles. As a result, the disclosed method is more efficient then known models when the number of particles is large while the grid dimension is reasonably small.

Referring back to FIG. 2, the resampling function [symbol] (s) is used in the disclosed embodiments to prevent particle degeneracy, a common issue where only a few particles have significant weights while the rest contribute little to the state estimate. Common resampling strategies mitigate this by discarding low-weight particles and duplicating high-weight particles to maintain a diverse and effective set of samples. Given the representation in equation (7), Gaussian splitting and merging may be performed to mimic discarding and duplicating Gaussians given their weights.

To prevent excessive Gaussians with low weights, Gaussians with low opacity are merged into their closest surviving neighbor. A Gaussian Gᵢ is considered for merging if:

$${\hat{σ}}^{( i )} < {τ}_{m} , \qquad ( 29 )$$

where τₘ is an opacity threshold. The merging process identifies the closest surviving Gaussian Gⱼ measured in Euclidean distance and updates its parameters as follows:

$${X}_{j} = \frac{{σ}_{i} {X}_{i} + {σ}_{j} {X}_{j}}{{σ}_{i} + {σ}_{j}} , {\sum }_{j} = \frac{{σ}_{i} {\sum }_{i} + {σ}_{j} {\sum }_{j}}{{σ}_{i} + {σ}_{j}} , {σ}_{j} = {σ}_{i} + {σ}_{j} \qquad ( 30 )$$

The Gaussian Gᵢ is then removed from the state representation.

To capture anisotropic deformations, Gaussians whose covariance matrix becomes highly elongated are split. Specifically, for each Gaussian Gᵢ, the ratio of itx maximum to minimum eigenvalue is computed:

$${r}_{i} = \frac{{S}_{max}^{( i )}}{{S}_{min}^{( i )}} , \qquad ( 31 )$$

and a Gaussian is selected for splitting if rᵢ>τₛ, where τₛ is a threshold controlling sensitivity of the splitting process.

When a Gaussian is selected for splitting, the Gaussian is decomposed along its principal axes. Given the eigenvalue decomposition of the covariance matrix

$${\sum }_{i} = {R}_{i} {S}_{i} {S}_{i}^{T} {R}_{i}^{T} ,$$

the splitting direction is chosen along the eigenvector eₘₐₓ corresponding to the larges scaling value

$${S}_{max}^{( i )} ,$$

mean Xᵢ:

$${X}_{1} = {X}_{i} + {ve}_{max} , {X}_{2} = {X}_{i} - {ve}_{max} \qquad ( 32 )$$

Both new components share the same variance σ², which is adjusted based on the displacement:

$${\sum }_{1} = {\sum }_{2} = ( 1 - {v}^{2} ) {\sum }_{i} \qquad ( 33 )$$

In the illustrated example, the mixture weights are set to 0.5 each, ensuring the total probability mass remains unchanged. The displacement parameter v is randomly sampled within the range [−1,1]. This method allows the system to refine object representation along dominant deformation directions while maintaining global consistency in the state estimation process.

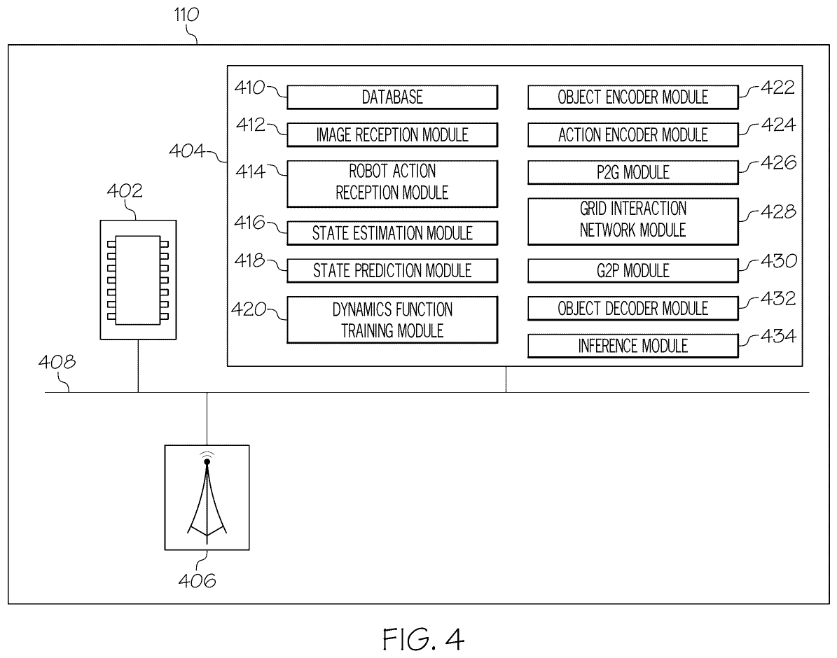

FIG. 4 schematically depicts the computing device 110 of FIG. 1. The computing device 110 may be used to predict future states of a deformable object based on a current state and a robot action, as disclosed herein.

In the example of FIG. 4, the computing device 110 comprises one or more processors 402, one or more memory modules 404, network interface hardware 406, and a communication path 408. The one or more processors 402 may be a controller, an integrated circuit, a microchip, a computer, or any other computing device. The one or more memory modules 404 may comprise RAM, ROM, flash memories, hard drives, or any device capable of storing machine readable and executable instructions such that the machine readable and executable instructions can be accessed by the one or more processors 402.

The network interface hardware 406 can be communicatively coupled to the communication path 408 and can be any device capable of transmitting and/or receiving data via a network. Accordingly, the network interface hardware 406 can include a communication transceiver for sending and/or receiving any wired or wireless communication. For example, the network interface hardware 406 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 406 includes hardware configured to operate in accordance with the Bluetooth® wireless communication protocol. The network interface hardware 406 of the computing device 110 may receive data from the cameras 106, 108 and the robot 104 in the example of FIG. 1.

The one or more memory modules 404 include a database 410, an image reception module 412, a robot action reception module 414, a state estimation module 416, a state prediction module 418, a dynamics function training module 420, an object encoder module 422, an action encoder module 424, a P2G module 426, a grid interaction network module 428, a G2P module 430, an object decoder module 432, and an inference module 434. Each of the database 410, the image reception module 412, the robot action reception module 414, the state estimation module 416, the state prediction module 418, the dynamics function training module 420, the object encoder module 422, the action encoder module 424, the P2G module 426, the grid interaction network module 428, the G2P module 430, the object decoder module 432, and the inference module 434 may be a program module in the form of operating systems, application program modules, and other program modules stored in the one or more memory modules 404. In some embodiments, the program module may be stored in a remote storage device that may communicate with the computing device 110. Such a program module may include, but is not limited to, routines, subroutines, programs, objects, components, data structures and the like for performing specific tasks or executing specific data types as will be described below.

The database 410 may store data received from the cameras 106, 108 and the robot 104. In particular, the database 410 may store training data used to train the dynamics model, as discussed above. The database 410 may also store the learned parameters of the neural network 300 after it is trained. The database 410 may also store camera intrinsics and extrinsics of the cameras 106, 108, along with other data that may be utilized by the computing device 110.

The image reception module 412 may receive image data of a robot interacting with a deformable object. In the example of FIG. 1, the image reception module 412 may receive data from the cameras 106, 108. During training, the image reception module 412 may receive a sequence of images of a deformable object being acted upon by a robot. This training data may be used to train the dynamics model, as disclosed herein. During inference, the image reception module 412 may receive a plurality of images of an object being acted upon by a robot at a single time step. These images, along with action data of the robot, may be input to the trained dynamics model to predict a future state of the deformable object.

The robot action reception module 414 may receive robot actions while a robot is interacting with a deformable object. As discussed above, the robot 104 may transmit data about actions being performed to the computing device 110. This action data may be received by the robot action reception module 414. During training, the robot action reception module 414 may receive a sequence of actions performed by a robot. This action data may be used in conjunction with the training data received by the image reception module 412 to train the dynamics model. During inference, the robot action reception module 414 may receive a single robot action, which may be used in conjunction with a single image of a deformable object to predict a future state of the deformable object.

The state estimation module 416 may estimate a state of a deformable object based on image data received by the image reception module 412, using the techniques described above. In particular, as discussed above, the state of an object may be modeled as a plurality of Gaussians, with the Gaussians considered as particles. The particles may be initialized to match the image data received by the state estimation module 416 using the rendering process of Gaussian splatting. As such, the state estimation module 416 may estimate an initial state of the deformable object at a time t=0.

After the state estimation module 416 estimates an initial state of the object at time t=0, the state prediction module 418 may predict a future state of the object at time t=1 based on the current state at t=0, and the action received by the robot action reception module 414, as discussed above. In particular, the state prediction module 418 may predict the state of the object at the next time step by implementing the two-step process described above; first performing the prediction step using the dynamics function [symbol] _{θ}(s, a), and then performing the update step using the resampling function [symbol] (s).

The dynamics function training module 420 may train the neural network 300 to learn the parameters of the dynamics function [symbol] _{θ}(s, a), as discussed above. As discussed above, the image reception module 412 and the robot action reception module 414 may receive training comprising a sequence of RGB-D images and a corresponding sequence of robot actions, respectively. After receiving the training data, the object encoder module 422 encodes the received image data to implement the object encoder 302 of the neural network 300. The action encoder module 424 encodes the received robot actions to implement the action encoder 304 of the neural network 300. The P2G module 426 converts the particle representation of the Gaussians to a grid representation as discussed above to implement the P2G module 306 of the neural network 300.

After the P2G module 426 determines the grid representation of the object particles and the grid representation of the action particles, the grid interaction network module 428 concatenates the grid representations of the object and the grid representation of the action and inputs the concatenation into the grid interaction network 308 of the neural network 300. The grid interaction network 308 then outputs a grid solution indicating the grid data at the next time step.

The G2P module 430 then converts the grid solution to a particle representation as discussed above to implement the G2P module 310 of the neural network 300. The object decoder module 432 then decodes the particle features to implement the object decoder 312 of the neural network 300 to generate the output dynamics of the object for the next time step.

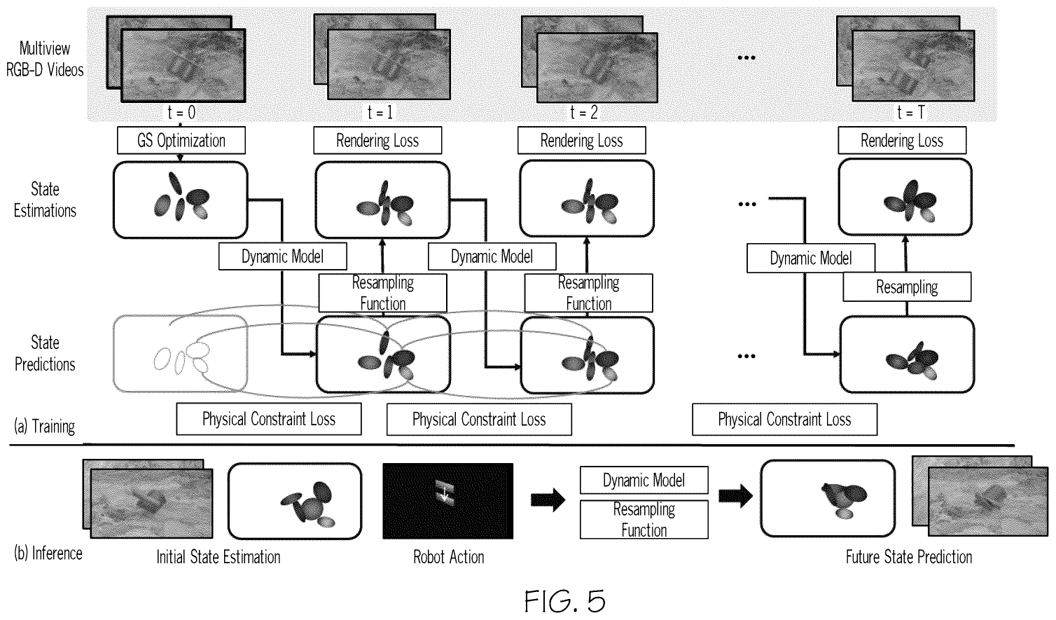

As discussed above, the dynamics function training module 420 may learn the parameters of the neural network 300 by optimizing the parameters against a rendering loss and a physical constraint loss. FIG. 5 illustrates this training process. As shown in FIG. 5, at training time, ground truth data comprising a plurality of RGB-D images at a plurality of time steps is received. The dynamics function training module 420 optimizes a Gaussian splatting representation of the static scene, and then optimizes the dynamic model through particle filtering over Gaussians, The optimization is supervised by rendering loss and physical constraint loss.

Referring back to FIG. 4, the inference module 434 may utilize the disclosed dynamics model, after it is trained, to predict a future state of an object based on a current state of the object and a robot action. In particular, the image reception module 412 may receive a plurality of RGB-D images of an object at a single time step, and the robot action reception module 414 may receive a robot action being performed on the object at that time step. The inference module 434 may input the received RGB-D images and robot action into the state estimation module 416 to estimate a current state of the object. The state prediction module 418 may then predict a future state of the object using the dynamics function [symbol] _{θ}(s, a) and the resampling function [symbol] (s), as discussed above. This is illustrated in the last row of FIG. 5.

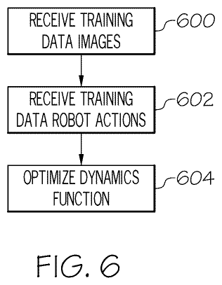

FIG. 6 depicts a flowchart of an example method for operating the computing device 110 for optimizing the parameters of the dynamics function, as disclosed herein. At step 600, the image reception module 412 receives training data comprising a plurality of RGB-D images of an object at a plurality of time steps. At step 602, the robot action reception module 414 receives training data comprising robot actions associated with the object at the plurality of time steps. At step 604, the dynamics function training module 420 optimizes dynamics function to predict a future state of the object based on a current state of the object and a robot action. As discussed above, the state of the object is estimated as a plurality of particles comprising 3D Gaussians using particle filtering.

It should now be understood that embodiments described herein are directed to particle filtering for learning object physics from robot interaction videos. In particular, a computing device can be trained to receive RGB-D images of a deformable object being interacted with by a robot, as well as the robot action being performed, and predict a future state of the object. This training may be performed for a plurality of objects such that a dynamics function may be learned for each such object, that is able to predict future states of the object based on a current state of the object and a robot action being performed on the object.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving training data comprising a plurality of RGB-D images of an object at a plurality of time steps, and a plurality of robot actions associated with the object at the plurality of time steps; and
optimizing, using the training data, a dynamics function to predict a future state of the object based on a current state of the object and a robot action,
wherein a state of the object is estimated as a plurality of particles comprising 3D Gaussians using particle filtering.

2. The method of claim 1, further comprising optimizing parameters of the dynamics function against a rendering loss and a physical constraint loss.

3. The method of claim 1, wherein the robot actions are represented by a second set of Gaussians.

4. The method of claim 1, wherein opacities of the particles comprise importance weights describing contributions of each Gaussian.

5. The method of claim 1, wherein the dynamics function comprises a neural network comprising:
an object encoder to encode the RGB-D images of the object;
an action encoder to encode the robot actions;
a particle-to-grid module to convert particle features to grid features;
a grid interaction network to determine a grid solution based on the grid features;
a grid-to-particle module to convert the grid solution to updated particle features; and
an object decoder to generate output dynamics based on the updated particle features.

6. The method of claim 5, wherein optimizing the dynamics function comprises learning parameters associated with the object encoder, the action encoder, the grid interaction network, and the object decoder.

7. The method of claim 1, further comprising optimizing the dynamics function to predict the future state of the object by:
predicting the future state of the object at a next time step; and
updating the future state of the object at the next time step based on a likelihood function.

8. The method of claim 1, further comprising:
receiving a second plurality of RGB-D images of the object at first time step;
receiving a second robot action associated with the object at the first time step;
estimating a state of the object at the first time step based on the second plurality of RGB-D images as a plurality of 3D Gaussians using particle filtering; and
predicting a second state of the object at a second time step based on the state of the object at the first time step, the second robot action, and the dynamics function.

9. The method of claim 8, further comprising adjusting weights of the 3D Gaussians based on a resampling function.

10. The method of claim 9, wherein the resampling function performs the steps of:
merging one or more of the 3D Gaussians having an opacity below a first predetermined threshold; and
splitting one or more of the Gaussians having a ratio of a maximum to minimum eigenvalue greater than a second predetermined threshold.

11. A computing device comprising one or more processors configured to:
receive training data comprising a plurality of RGB-D images of an object at a plurality of time steps, and a plurality of robot actions associated with the object at the plurality of time steps; and
optimize, using the training data, a dynamics function to predict a future state of the object based on a current state of the object and a robot action,
wherein a state of the object is estimated as a plurality of particles comprising 3D Gaussians using particle filtering.

12. The computing device of claim 11, wherein the one or more processors are further configured to optimize parameters of the dynamics function against a rendering loss and a physical constraint loss.

13. The computing device of claim 11, wherein the robot actions are represented by a second set of Gaussians.

14. The computing device of claim 11, wherein opacities of the particles comprise importance weights describing contributions of each Gaussian.

15. The computing device of claim 11, wherein the dynamics function comprises a neural network comprising:
an object encoder to encode the RGB-D images of the object;
an action encoder to encode the robot actions;
a particle-to-grid module to convert particle features to grid features;
a grid interaction network to determine a grid solution based on the grid features;
a grid-to-particle module to convert the grid solution to updated particle features; and
an object decoder to generate output dynamics based on the updated particle features.

16. The computing device of claim 15, wherein the one or more processors are configured to optimize the dynamics function by learning parameters associated with the object encoder, the action encoder, the grid interaction network, and the object decoder.

17. The computing device of claim 11, wherein the one or more processors are further configured to optimize the dynamics function to predict the future state of the object by:
predicting the future state of the object at a next time step; and
updating the future state of the object at the next time step based on a likelihood function.

18. The computing device of claim 11, wherein the one or more processors are further configured to:
receive a second plurality of RGB-D images of the object at first time step;
receive a second robot action associated with the object at the first time step;
estimate a state of the object at the first time step based on the second plurality of RGB-D images as a plurality of 3D Gaussians using particle filtering; and
predict a second state of the object at a second time step based on the state of the object at the first time step, the second robot action, and the dynamics function.

19. The computing device of claim 18, wherein the one or more processors are further configured to adjust weights of the 3D Gaussians based on a resampling function configured to:
merge one or more of the 3D Gaussians having an opacity below a first predetermined threshold; and
split one or more of the Gaussians having a ratio of a maximum to minimum eigenvalue greater than a second predetermined threshold.

20. A non-transitory computer readable storage medium storing a program that when executed by a processor, causes the processor to:
receive training data comprising a plurality of RGB-D images of an object at a plurality of time steps, and a plurality of robot actions associated with the object at the plurality of time steps; and
optimize, using the training data, a dynamics function to predict a future state of the object based on a current state of the object and a robot action,
wherein a state of the object is estimated as a plurality of particles comprising 3D Gaussians using particle filtering.
